(19) United States
(12) Patent Application Publication
(10) Pub. No.: US 2013/0159051 A1
(43) Pub. Date: Jun. 20, 2013

(54) System and Method for Enhanced Information Gathering

(71) Applicant: Sybase 365, Inc., Reston, VA (US)

(72) Inventor: Michael Timmons, San Jose, CA (US)

(73) Assignee: SYBASE 365, INC., Reston, VA (US)

(21) Appl. No.: 13/716,613

(22) Filed: Dec. 17, 2012

Related U.S. Application Data
(60) Provisional application No. 61/570,895, filed on Dec. 15, 2011.

(51) Int. Cl. G06Q 30/02

(52) U.S. Cl. CPC G06Q 30/0201
USPC 705/7.29

(57) ABSTRACT

A flexible, extensible, and dynamically configurable Content Collection, Aggregation, and Enhancement Facility (CCAEF) that a (e.g., small or mid-size) merchant may employ and which would leverage aspects of the merchant's existing infrastructure (such as for example a merchant's Web site)—with for example no or minimal effort or intervention on the part of the merchant—to inter alia develop all of the required data so that the merchant can fully engage a Real-Time Offer Management System (RTOMS), or other such system, and thus more effectively compete with large merchants in the world of commerce.

This application claims the benefit of U.S. Provisional Patent Application Ser. No. 61/570,895, filed on 15 Dec. 2011, which is incorporated herein in its entirety.

### BACKGROUND

1. Field of the Invention

The present invention relates generally to merchant systems. More particularly, the present invention relates to capabilities that enhance substantially the ability of a (for example small) merchant to fully participate in the world of electronic commerce.

2. Background of the Invention

In today's competitive economy merchants are continually struggling to fully, effectively, etc. compete in the world of electronic commerce or e-commerce. Broadly stated, e-commerce encompasses the buying and the selling of products, services, etc. through electronic systems such as inter alia the Internet (and, by extension, the World Wide Web (WWW) which sits atop the Internet).

To suggest that e-commerce is a lucrative space is something of an understatement. For example, Forrester Research predicts that in the U.S. alone the value of e-commerce will be approximately $197b in 2011, up from approximately $176b in 2010.

One way in which a merchant may improve their potential e-commerce success is through the use of for example a Real-Time Offer Management System (RTOMS). Such a dynamic, adaptive, configurable, etc. real-time system can inter alia analyze a range of information (including among other things inventory data, sales data, customer information, etc.); generate among other things prices using inter alia rules, targets, constraints, etc.; identify for example up-sell, discount, coupon, targeted-sale, etc. opportunities; etc.

However, for such a system to be effective it needs data from a merchant. In particular, it needs:

1) Initial Data. Definitional, descriptive, etc. information on possibly inter alia a merchant's products and services, customers, suppliers, partners, vendors, etc.

2) Updated Data. Information on possibly inter alia a merchant's current inventory levels, current prices, sales activity, etc.

Such data may be collected from a merchant, aggregated, manipulated, enhanced, etc. and then possibly inter alia preserved in one or more of a RTOMS′ repositories for subsequent use by the RTOMS.

For large merchants, with among other things dedicated Information Technology (IT) staffs and abundant computing resources, supplying the required data is not a problem. They can easily create, deploy, manage, etc. all of the necessary communication interfaces, data collection and manipulation processes, etc. to retrieve data from their systems, perform the necessary processing operations, and pass the necessary and appropriate information to a RTOMS.

But what about the rest of the (e.g., small and mid-size) merchants? They typically do not have their own IT staffs and frequently have minimal computing resources. How can data from their operations be collected, processed, etc. so that they can fully engage a RTOMS and thus compete without disadvantage with large merchants?

What is needed is an efficient, low-impact, etc. information collection, processing, aggregation, enhancement, etc. facility that a (e.g., small or mid-size) merchant may employ and which would leverage aspects of the merchant's existing infrastructure (such as for example a merchant's Web site)—with for example no or minimal effort or intervention on the part of the merchant—to inter alia develop all of the required data so that the merchant can fully engage a RTOMS (or other such system) and thus more effectively compete with large merchants.

Aspects of the present invention address the lacuna that was noted above by (1) providing a Content Collection, Aggregation, and Enhancement Facility (CCAEF) while (2) addressing, in new and innovatory ways, various of the not insubstantial challenges that are associated with same.

### SUMMARY OF THE INVENTION

In one embodiment of the present invention there is provided a computing device-implemented method for a CCAEF comprising (a) receiving a first set of data from a merchant system, (b) processing the received data to at least extract one or more details, parse the extracted details, and generate one or more Feature Tags (FTs), and (c) sending a second set of data to a RTOMS.

Further features and advantages of the present invention, as well as the structure and operation of various embodiments thereof, are described in detail below with reference to the accompanying drawings. It should be noted that the invention is not limited to the specific embodiments described herein. Such embodiments are presented herein for illustrative purposes only. Additional embodiments will be readily apparent to persons skilled in the relevant arts based on the teachings contained herein.

### BRIEF DESCRIPTION OF THE DRAWINGS

The accompanying drawings, which are incorporated herein and form part of the specification, depict embodiments of the present invention and, together with the summary that was presented above and the description that may be found below, further serve to illustrate inter alia the principles, structure, and operation of such embodiments. It will be readily apparent to one of ordinary skill in the relevant art that numerous variations, modifications, alternative forms, etc. of the depicted embodiments are easily possible and indeed are within the scope of the present invention.

FIGS. 1, 2, and 3 are diagrammatic presentations of possible exemplary CCAEF arrangements.

FIG. 4 illustrates various of the exchanges that are possible under aspects of the present invention.

FIG. 5 illustrates various implementation aspects of an exemplary CCAEF.

FIG. 6 illustrates various implementation aspects of an exemplary CCAEF Data Processing Engine (DPE).

FIG. 7 illustrates a hypothetical Feature Tag (FT) that is possible under aspects of the instant invention.

FIG. 8 depicts aspects of a hypothetical WorkFlow implementation that is possible under aspects of the present invention.

FIG. 9 depicts an exemplary computer system through which embodiments of aspects of the present invention may be implemented.

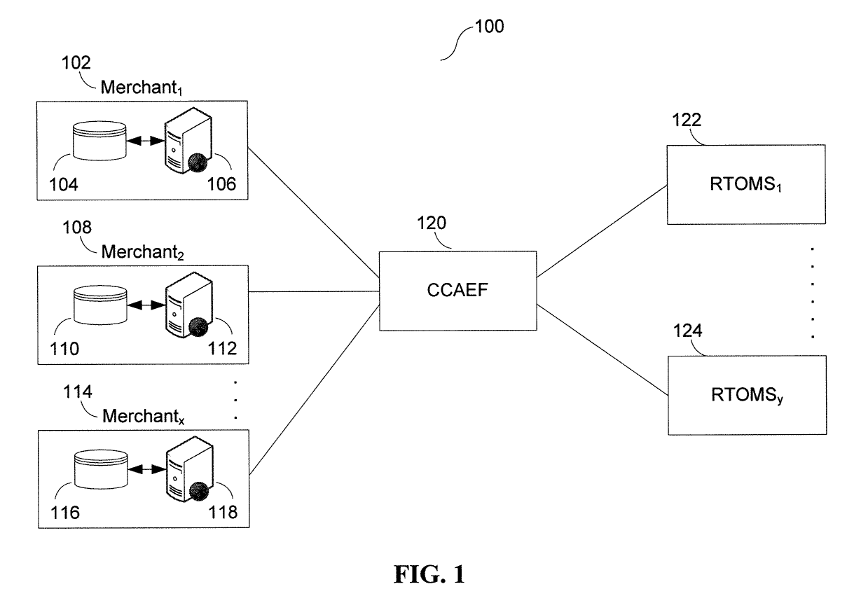

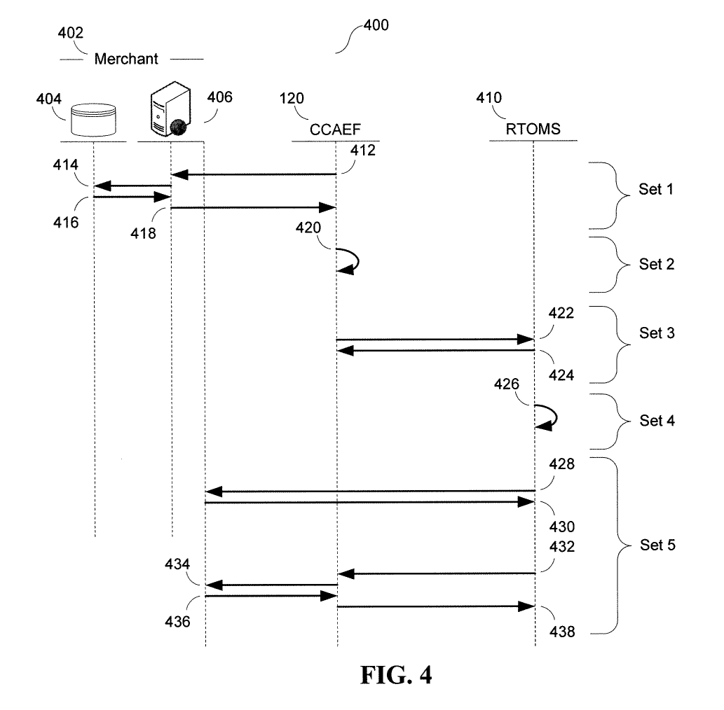

The present invention will now be described with reference to the accompanying drawings. In the drawings, generally, like reference numbers indicate identical or functionally similar elements. Additionally, generally, the left-most digit(s) of a reference number identifies the drawing in which the reference number first appears. For example, in FIG. 4 the reference numeral 120 would direct the reader to FIG. 1 for the first appearance of that reference numeral.

### DETAILED DESCRIPTION OF THE INVENTION

The following detailed description of the present invention refers to the accompanying drawings that illustrate exemplary embodiments consistent with aspects of this invention. Other embodiments are possible, and modifications can be made to the embodiments within the spirit and scope of the invention. Therefore, the detailed description is not meant to limit the invention.

To provide some context for the discussion that will follow, consider for a moment the exemplary CCAEF 120 that is depicted (albeit only partially, at a high-level, and from a logical perspective) in FIG. 1 and reference numeral 100.

The illustrated CCAEF 120 is disposed between, possibly inter alia, multiple merchants (Merchant₁ 102, Merchant₂ 108, . . . Merchantₓ 114 ) on one side and multiple RTOMS s (RTOMS₁ 122→RTOMS_{y} 124) on the other side and is, in effect, a horizontally and vertically scalable ‘hub’ that may among other things ‘bridge’ all of the connected entities and inter alia facilitate the ubiquitous collection, exchange, etc. of information (including, inter alia, inventory details, pricing information, sale activity, customer information, etc.) between various of the connected participants.

A merchant (such as Merchant₁102→Merchantₓ 114) may contain among other things a Web server (such as 106, 112, and 118) and a repository (such as 104, 110, and 116).

A Web server (such as 106→118) may host among other things a merchant's public Web site. Such a public Web site may be simple (e.g., offering just the static display of the merchant's product/service information) or it may be advanced (e.g., offering various product/service inquiry, purchase, etc. capabilities).

A repository (such as 104→116) may house aspects of a merchant's product and service offerings (e.g., product information, pricing data, customer information, sales data, etc.) and may inter alia support a merchant's Web server (such as 106→118).

So positioned, a CCAEF 120 can among other things leverage a merchant's existing infrastructure, such as for example a Web server (such as 106→118) and/or a repository (such as 104→116), to possibly inter alia (1) collect, process, aggregate, enhance, etc. various of a merchant's data (such as for example inventory count, price details, sales data, etc.)—with for example no or minimal effort or intervention on the part of the merchant—and (2) pass the appropriate, necessary, etc. information to a RTOMS (such as 122→124), again with for example no or minimal effort or intervention by the merchant.

It is important to note that a CCAEF 120 may:

1) Connect with any combination of other entities (beyond merchants and RTOMSs) such as inter alia clearinghouses, manufacturers, vendors, etc.

2) Pull data—such as for example demographic data, psychographic data, census data, etc.—from a range of internal and/or external sources as it completes its different processing activities.

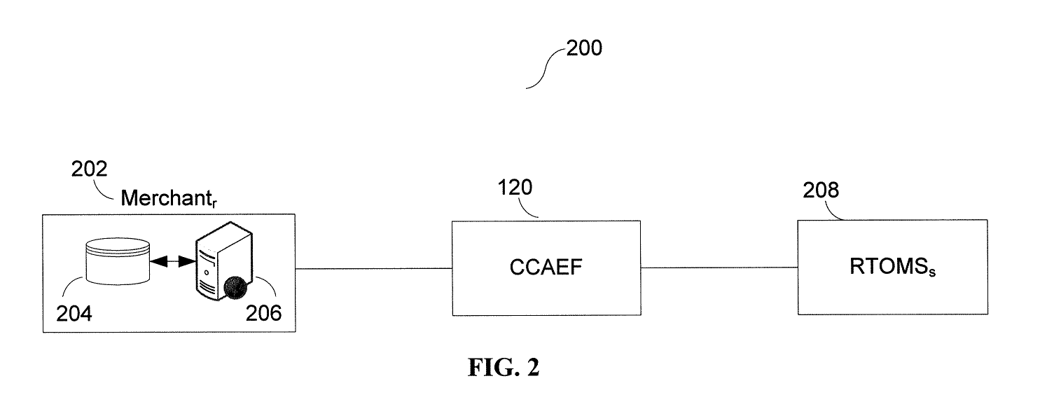

While the discussion above employed a centrally-located CCAEF supporting multiple merchants and multiple RTOMS, it will be readily apparent to one of ordinary skill in the relevant art that numerous other arrangements are equally applicable and indeed are fully within the scope of the present invention. As just one example, FIG. 2 and reference numeral 200 depict a centrally-located CCAEF 120 supporting, possibly inter alia, a single merchant (Merchant, 202, comprising possibly inter alia a Web server 206 and a repository 204) and a single RTOMS (RTOMSₛ 208).

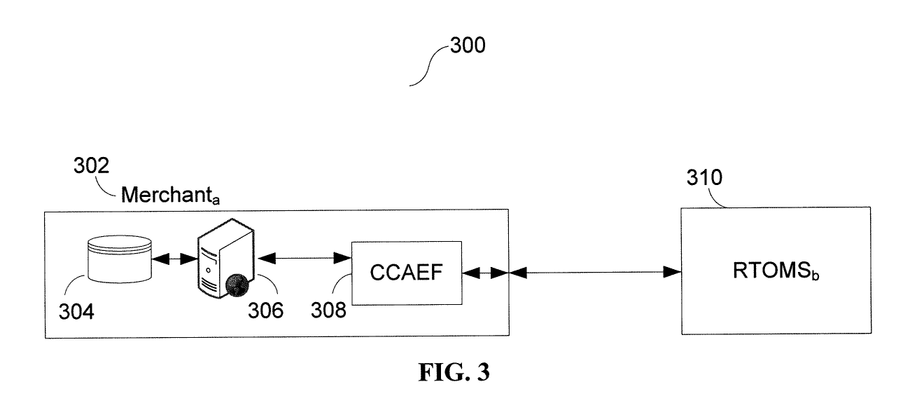

While the discussion above focused on a centrally-located CCAEF, it will be readily apparent to one of ordinary skill in the relevant art that numerous other arrangements are equally applicable and indeed are fully within the scope of the present invention. As just one example, FIG. 3 and reference numeral 300 depict one possible alternative arrangement. As the diagram portrays, a CCAEF 308 is resident within a merchant (Merchantₐ 302, comprising possibly inter alia a Web server 306 and a repository 304) and supports possibly inter alia communication with a RTOMS (RTOMS_{b} 310). As another example, a CCAEF could reside within a RTOMS. Numerous other examples are easily possible.

It is important to note that in FIGS. 1, 2, and 3 the indicated component connections (between for example a CCAEF, a merchant, a Web server, a repository, etc.) are illustrative only and numerous other connections are equally applicable and indeed are fully within the scope of the present invention. As one possible example, a CCAEF may interact with, and thus connect with, just a merchant's repository. As another possible example, a CCAEF may interact with, and thus connect with, a merchant's Web server and repository.

It is clear from the above discussion that numerous CCAEF implementation approaches are possible. In general, aspects of a CCAEF may be offered by any combination of, possibly inter alia, one or more of (1) an element of a merchant, an element of a RTOMS, or multiple such elements working together; (2) a Third Party (3P) such as possibly inter alia a service provider, a content provider (such as for example a news organization, an advertising agency, a brand, etc.), a financial institution, a distributor, etc.; (3) multiple 3P entities working together; (4) a service bureau; and/or (5) other entities.

For variety, completeness, etc. of exposition, portions of the discussion below will include a separate merchant, CCAEF, and RTOMS. As noted above, it will be readily apparent to one of ordinary skill in the relevant art that numerous other arrangements are easily possible (involving for example any combination of one or more of inter alia the identified and/or other entities).

In the discussion below reference is made to ‘messages’ (data, results, etc.) that may be sent, for example, between a merchant and a RTOMS. As set forth below, a given message sent between a merchant and a RTOMS may actually comprise a series of steps in which the message is received, forwarded and routed between different entities, including possibly inter alia a merchant, a CCAEF, and a RTOMS. Thus, unless otherwise indicated, it will be understood that reference to a particular message generally includes that particular message as conveyed at any stage between an origination source, such as for example a merchant, and an end receiver, such as for example a RTOMS. As such, reference to a particular message generally includes a series of related communications between, for example, a merchant and a CCAEF; a CCAEF and a RTOMS; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example. Our hypothetical example includes, possibly inter alia, a merchant, a CCAEF, and a RTOMS.

FIG. 4 and reference numeral 400 illustrate various of the exchanges or interactions that might occur under our hypothetical example. Of interest and note in the diagram are the following entities:

Merchant 402. A merchant comprising inter alia a Web server 406 and a repository 404.

CCAEF 120. A centrally-located CCAEF.

RTOMS 410. A RTOMS.

In FIG. 4 the exchanges that are collected under the designation Set 1 represent the activities that might take place as information is gathered by a CCAEF 120 from a merchant 402 (see for example 412, 414, 416, and 418). For example, a CCAEF 120 may access a Web site 406 of the merchant 402 to inter alia spider, index, etc. the site; retrieve data (such as for example individual pages, page objects, etc.) from the site; etc. Such access may be accomplished through any combination of one or more of possibly inter alia HyperText Transfer Protocol (HTTP), HyperText Transfer Protocol Secure (HTTPS), a proprietary communications protocol, etc. and may yield any combination of one or more of possibly inter alia a HyperText Markup Language (HTML) document, an eXtensible HyperText Markup Language (XHTML) document, an Extensible Markup Language (XML) document, a body of simple text, raw data, etc.

The specific exchanges that were described above (as residing under the designation Set 1) are illustrative only and it will be readily apparent to one of ordinary skill in the relevant art that numerous other exchanges are easily possible and indeed are fully within the scope of the present invention. For example, a CCAEF 120 may access other elements (such as inter alia a repository 404) of a merchant 402, instead of or in addition to a Web site 406 of the merchant 402, and retrieve data (such as for example fields, records, files, etc.) from same.

In FIG. 4 the exchanges that are collected under the designation Set 2 represent the activities that might take place as a CCAEF 120 completes various processing activities (see 420) including possibly inter alia:

A) Parse, process, etc. aspects of the retrieved data and possibly among other things extract details (including for example identifiers, names, descriptions, unit prices, available quantities, sale details, dates and times, etc.). Among other things, a retrieved Web page may be evaluated in one or more ways (e.g., outside-in, inside-out, etc.); decomposed into a collection of objects (e.g., tables, textual blocks, graphic images, etc.); links and other references on the page may be resolved, replaced, mapped, etc.; etc.

B) As appropriate and as required review, edit, validate, normalize, map, replace, etc. various of the extracted details.

C) As appropriate and as required enhance, augment, etc. different values using possibly among other things one or more internal and/or external sources of data.

D) As appropriate and as required aggregate, analyze, etc. various of the information.

E) Generate one or more FTs. As will be described in detail below, a FT is effectively a compact digest of key data elements, thus providing inter alia a representation of or an alias for or a ‘fingerprint’ of those data elements. For example, a FT may be generated for various of the objects (e.g., textual blocks, etc.) that are extracted from a retrieved Web page.

F) Preserve aspects of the processing activity in for example a repository.

The specific exchanges that were described above (as residing under the designation Set 2) are illustrative only and it will be readily apparent to one of ordinary skill in the relevant art that numerous other exchanges are easily possible and indeed are fully within the scope of the present invention. Among other things, various of the processing activities may leverage a body of flexible, extensible, and dynamically configurable rules, may employ fuzzy logic, may leverage various internal and/or external data sources, etc.

In FIG. 4 the exchanges that are collected under the designation Set 3 represent the activities that might take place as a CCAEF 120 passes information to a RTOMS 410 (see 422 424). Among other things a CCAEF 120 may:

A) Map, transform, etc. aspects of the information as appropriate and as required to inter alia accommodate data format, structure, content, etc. requirements of a RTOMS 410.

B) Pass the information in any form (e.g., as a XML document, as simple text, etc.) using among other things either some publicly available communication protocol or some proprietary communication protocol. Additionally, such an exchange may leverage one or more Application Programming Interfaces (APIs).

C) Encrypt aspects of the information (to enhance security) and/or compress aspects of the information (to enhance efficiency).

The specific exchanges that were described above (as residing under the designation Set 3) are illustrative only and it will be readily apparent to one of ordinary skill in the relevant art that numerous other exchanges are easily possible and indeed are fully within the scope of the present invention.

In FIG. 4 the exchanges that are collected under the designation Set 4 represent the activities that might take place as a RTOMS 410 completes various processing activities (see 426) including possibly inter alia dynamically calculating prices; identifying coupon, discount, up-sell, etc. opportunities; etc. using inter alia rules, targets, constraints, fuzzy logic, etc.

The specific exchanges that were described above (as residing under the designation Set 4) are illustrative only and it will be readily apparent to one of ordinary skill in the relevant art that numerous other exchanges are easily possible and indeed are fully within the scope of the present invention.

In FIG. 4 the exchanges that are collected under the designation Set 5 represent the activities that might take place as a RTOMS 410 provides (e.g., dynamically generated price, etc.) information to a merchant 402. Among other things:

A) A RTOMS 410 may convey information, etc. to a merchant 402 directly (see 428→430), via a CCAEF (see 432, 434, 436, and 438), or through some other manner.

B) A RTOMS 410 may provide to a merchant's Web server 406 one or more updated, replacement, etc. Web pages comprising for example dynamically generated price information. Such material may be conveyed as inter alia simple text, a HTML document, a XHTML document, a XML document, etc.

C) A RTOMS 410 may provide to a merchant 402 updates for just a portion of a Web page on the merchant's Web server 406 (to be applied to, integrated in to, etc. the Web page by the merchant 402). Such material may be conveyed as inter alia simple text, a HTML document, a XHTML document, a XML document, raw data, etc.

D) A RTOMS 410 may provide to a merchant 402 data comprising for example dynamically generated price information to be recorded in the merchant's repository 404. Such material may be conveyed as inter alia simple text, a XML document, structured data, raw data, delimited data, etc. and may among other things make use of one or more APIs.

The specific exchanges that were described above (as residing under the designation Set 5) are illustrative only and it will be readily apparent to one of ordinary skill in the relevant art that numerous other exchanges are easily possible and indeed are fully within the scope of the present invention.

One or more of the exchanges that were described above (as residing under the designation Set 1→Set 5) may be repeated, in any order and as depicted or in an altered form, on a scheduled basis (e.g., every minute, every hour, etc.), on an as-needed basis (e.g., in response to a specific request from a merchant arising from for example an action by a customer of the merchant, etc.), as a result of some trigger event, on a random basis, etc. to inter alia refresh aspects of a RTOMS' data and yield new (e.g., price, etc.) information from the RTOMS. It is important to note that:

A) During such activities a RTOMS may leverage a previously-generated FT value to quickly determine if something (e.g., an inventory count, a price, etc.) has changed. If for example a newly-generated FT ‘matches’ a previously-calculated FT then a CCAEF might skip various time consuming and resource expensive processing, calculation, updating, etc. tasks. On the other hand, if a newly-generated FT does not ‘match’ a previously-calculated FT (e.g., perhaps the price, inventory level, etc. of a merchant's item has changed) then a CCAEF might invoke various processing activities (such as those described above) to inter alia result in a RTOMS receiving updated information from the CCAEF.

B) The constraints under which such activities take place may leverage a body of flexible, extensible, and dynamically configurable rules, parameters, schedules, etc.

The Set 1→Set 5 exchanges that were described above are illustrative only and it will be readily apparent to one of ordinary skill in the relevant art that numerous other exchanges are easily possible and indeed are fully within the scope of the present invention.

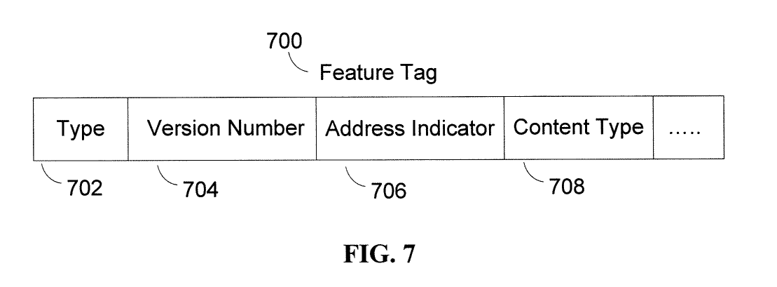

As noted above, aspects of a CCAEF may optionally generate, and possibly preserve, one or more FTs. A FT (see for example FIG. 7 and reference numeral 700) is effectively a compact digest of key data elements, thus providing inter alia a representation of or an alias for or a ‘fingerprint’ of those data elements, and may be based on possibly inter alia attributes, elements, etc. of a body of data (e.g., a portion of a page at a merchant's Web site).

Once generated, a FT may be quickly referenced by other elements of a CCAEF environment, as those elements complete their processing activities, to for example quickly and efficiently determine if something (e.g., an inventory count as presented on a page at a merchant's Web site) has changed.

For a discussion of aspects of a FT see for example U.S. Pat. No. 7,240,067 titled “System and Methodology for Extraction and Aggregation of Data from Dynamic Content,” pending U.S. patent application Ser. No. 12/140,478 titled “System and Method for Enhanced Message Routing,” and any associated continuation patent applications, each of which is herein incorporated by reference in its entirety.

As just described, a FT is effectively a compact digest of key data elements, thus providing inter alia a representation of or an alias for or a ‘fingerprint’ of those data elements.

FTs may follow an organized naming scheme and the naming scheme may incorporate an encoding model, may be organized in any number of ways (including for example alphabetically, nested, hierarchically, etc.), and may be searched or matched against in numerous ways (including for example sequentially, through wildcards, etc.).

For purposes of illustration, consider a simple FT model that is designed to support the processing, etc. of a Web page. Under such a model a hypothetical FT might be W0Q3R9TABMMZAE. Such a FT may comprise a number of elements (e.g., W|0|Q3R9TABMMZAE separated for purposes of display by a ‘|’) such as:

1) A type indicator (see reference numeral 702 in FIG. 7). For example, ‘W’ for Web page.

2) A version number (see reference numeral 704 in FIG. 7). For example, 0, 1, 2, etc. to allow for possibly inter alia future expansion, backwards compatibility, etc.

3) An address indicator (see reference numeral 706 in FIG. 7). The index, mapping, encoding, one-way hash, etc. of the address (such as inter alia a Uniform Resource Locator (URL)) of the Web page. For example, ‘Q3R9.’

4) A content type indicator (see reference numeral 708 in FIG. 7). For example, ‘G’ for a graphic element, ‘T’ for a textual element, etc. from the Web page.

5) Content encoding. The index, mapping, encoding, one-way hash, etc. of the instant piece of content. For example, ‘ABMMZA.’

6) A FT size indicator. For example, ‘9’ for a total size of 9, ‘B’ for a total size of 11, ‘E’ for a total size of 14, ‘H’ for a total size of 17, etc.

It will be readily apparent to one of ordinary skill in the relevant art that numerous other FT elements and/or FT element arrangements are possible within the illustrative model that was presented above.

Additionally, it will be readily apparent to one of ordinary skill in the relevant art that numerous other FT models, beyond the illustrative model that was presented above, are easily possible.

As noted previously, a collection of FTs may optionally be organized in any number of ways including inter alia hierarchically, in a nested fashion, alphabetically, by size, etc.

Aspects of the processing, searching, matching, etc. of FTs may optionally employ wild card characters. For purposes of illustration, under the illustrative FT model that was presented above with the hypothetical FT W0Q3R9TABMMZAE any number of searches, comparisons, etc. may be quickly completed using wild cards:

1) W*. Just Web pages.

2) ?0*. Just version 0 FTs.

3) W?Q3R9*. Just FTs that were generated from the Web page with the index, mapping, encoding, one-way hash, etc. of the Web page address (such as inter alia URL) ‘Q3R9.’

4) Etc.

It will be readily apparent to one of ordinary skill in the relevant art that numerous other FT processing, searching, matching, etc. mechanisms are easily possible including inter alia regular expressions, formal grammars, etc.

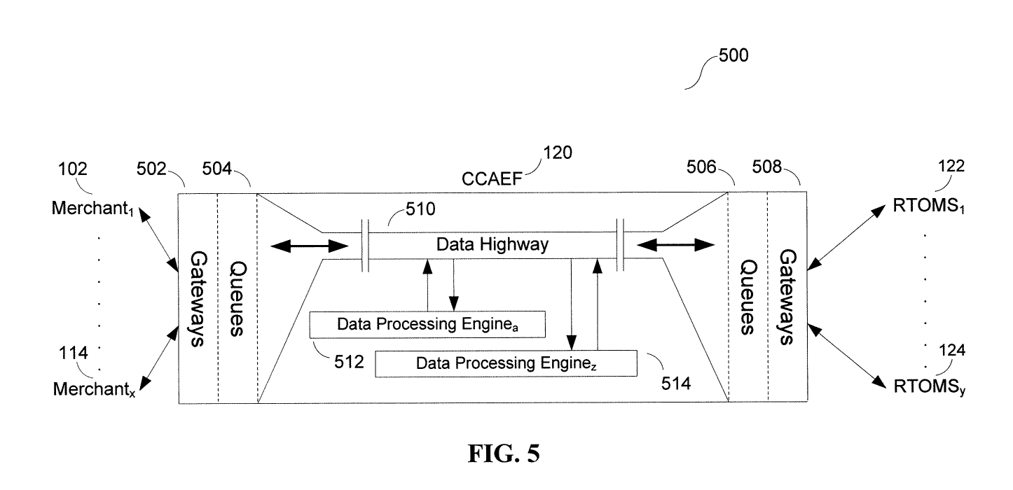

For purposes of illustration, FIG. 5 and reference numeral 500 depict a possible logical implementation of aspects of a CCAEF 120 under one particular arrangement. Under the illustrated arrangement a CCAEF 120 is disposed between, possibly inter alia, different merchants (Merchant₁ 102→Merchantₓ 114) and different RTOMSs (RTOMS₁ 122→RTOMS_{y} 124). The figure depicts among other things Gateways (502 and 508 that for example provide information/data receipt and dispatch capabilities across possibly inter alia different application-level communication protocols), Queues (504 and 506 that for example provide interim storage and buffering capabilities), a Data Highway (DH 510, that for example provides interconnection capabilities), and DPEs 512→514.

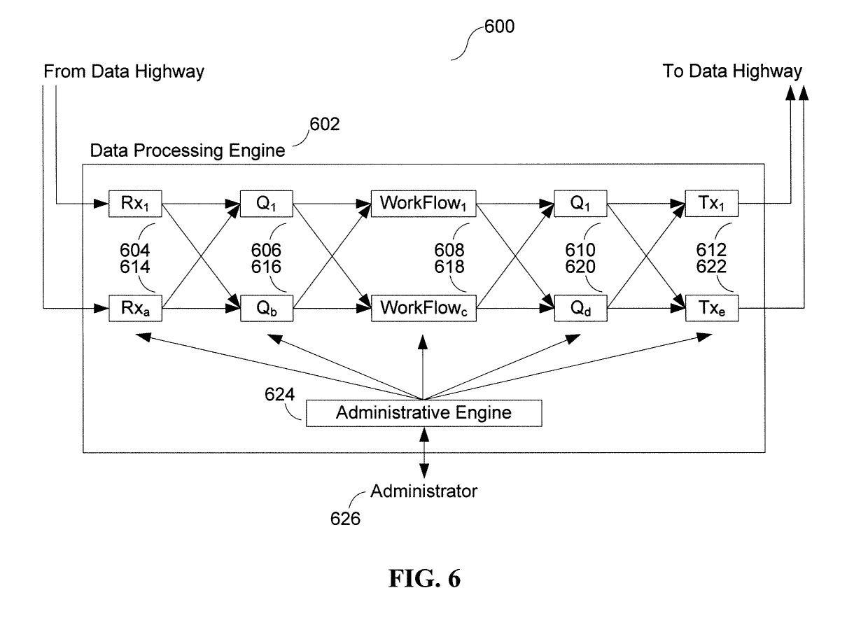

FIG. 6 and reference numeral 600 depict a possible logical implementation of aspects of a DPE 602. A DPE may contain among other things several key components—Receivers (Rx₁ 604→Rxₐ 614 in the diagram), Queues (Q₁ 606→Qb_{b} 616 and Q₁ 610→Q_{d} 620 in the diagram), WorkFlows (WorkFlow₁ 608→WorkFlow_{c} 618 in the diagram), Transmitters (Tx₁ 612→Txₑ 622 in the diagram), and an Administrator 626. It will be readily apparent to one of ordinary skill in the relevant art that numerous other components are possible within a DPE 602.

A dynamically updateable set of one or more Receivers (Rx₁ 604→Rxₐ 614 in the diagram) ‘get’ data from a CCAEF DH and deposit same on an intermediate or temporary Queue (Q₁ 606→Q_{b} 616 in the diagram) for subsequent processing.

A dynamically updateable set of one or more Queues (Q₁ 606→Q_{b} 616 and Q₁ 610→Q_{d} 620 in the diagram) operate as intermediate or temporary buffers for incoming and outgoing data.

A dynamically updateable set of one or more WorkFlows (WorkFlow₁ 608→WorkFlow_{c} 618 in the diagram) remove incoming data from an intermediate or temporary Queue (Q₁ 606→Q_{b} 616 in the diagram), perform all of the required operations on the data, and deposit the processed data, results, etc. on an intermediate or temporary Queue (Q₁ 610→Q_{d} 620 in the diagram). The WorkFlow component may among other things implement various of the CCAEF processing activities (such as inter alia the retrieval of data from a merchant, the generation of FTs, the conveyance of information to a RTOMS, etc.) that were described above.

A dynamically updateable set of one or more Transmitters (Tx₁ 612→Txₑ 622 in the diagram) remove processed data, results, etc. from an intermediate or temporary Queue (Q₁610→Q_{d} 620 in the diagram) and ‘put’ same on a CCAEF DH.

An Administrative Engine 624 provides a linkage to all of the different components of a DPE 602 so that a DPE 602, along with all of the different components of a DPE 602, may be fully and completely administered or managed through, as just one example, a WWW-based interface. It will be readily apparent to one of ordinary skill in the relevant art that numerous other interfaces (e.g., a data feed, an API, etc.) are easily possible.

A CCAEF 120 may contain any number of other elements beyond those which are explicitly depicted in FIG. 5. For example, a CCAEF may contain one or more repositories to support, inter alia, configuration, processing, monitoring, logging, reporting, etc. information. Such repositories may be implemented through any combination of conventional Relational Database Management Systems (RDBMSs), through Object Database Management Systems (ODBMSs), through in-memory Database Management Systems (DBMSs), or through any other equivalent facilities. Among other things, such repositories may be used to support:

1) Scheduled (e.g., daily, weekly, etc.) and/or on-demand reporting with report results delivered through Short Message Service (SMS), Multimedia Message Service (MMS), etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, etc. messages; through E-Mail; through a WWW-based facility; etc.

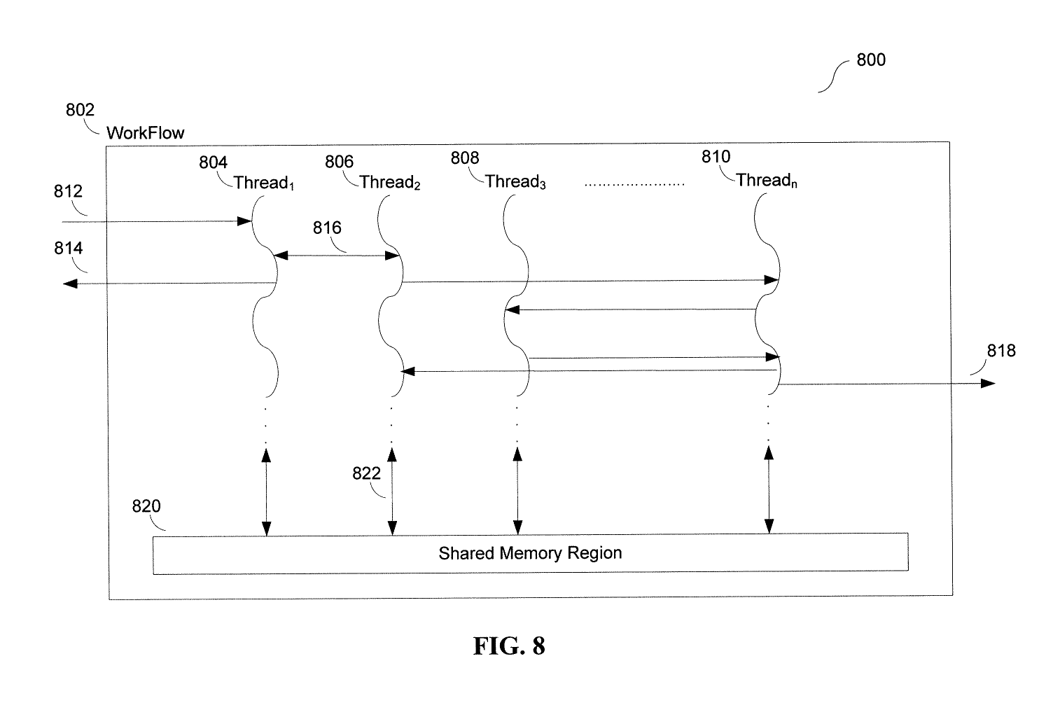

For purposes of illustration FIG. 8 and reference numeral 800 depict aspects of an exemplary WorkFlow environment 802 wherein possibly inter alia:

1) A dynamically adjustable number of threads (Thread₁ 804, Thread₂ 806, Thread₃ 808, . . . Threadₙ 810) may be inter alia created, started, allowed to operate or execute, quiesced, stopped, destroyed, etc. under control of for example the WorkFlow environment 802. Among other things one or more threads may for example realize, support, etc. aspects of one or more elements of a CCAEF (such as described above) and/or a single thread may for example realize aspects of one or more elements of a CCAEF (such as described above).

2) Different elements of a CCAEF (such as described above) may communicate, interact, etc. with various of the threads (Thread₁ 804→Threadₙ 810) (see for example 812, 814, and 818).

3) Various of the threads (Thread₁ 804→Threadₙ 810) may among themselves communicate, interact, etc. (see for example 816).

4) Various of the threads (Thread₁ 804→Threadₙ 810) may communicate, interact, etc. with inter alia a Shared Memory Region (820) (see for example 822).

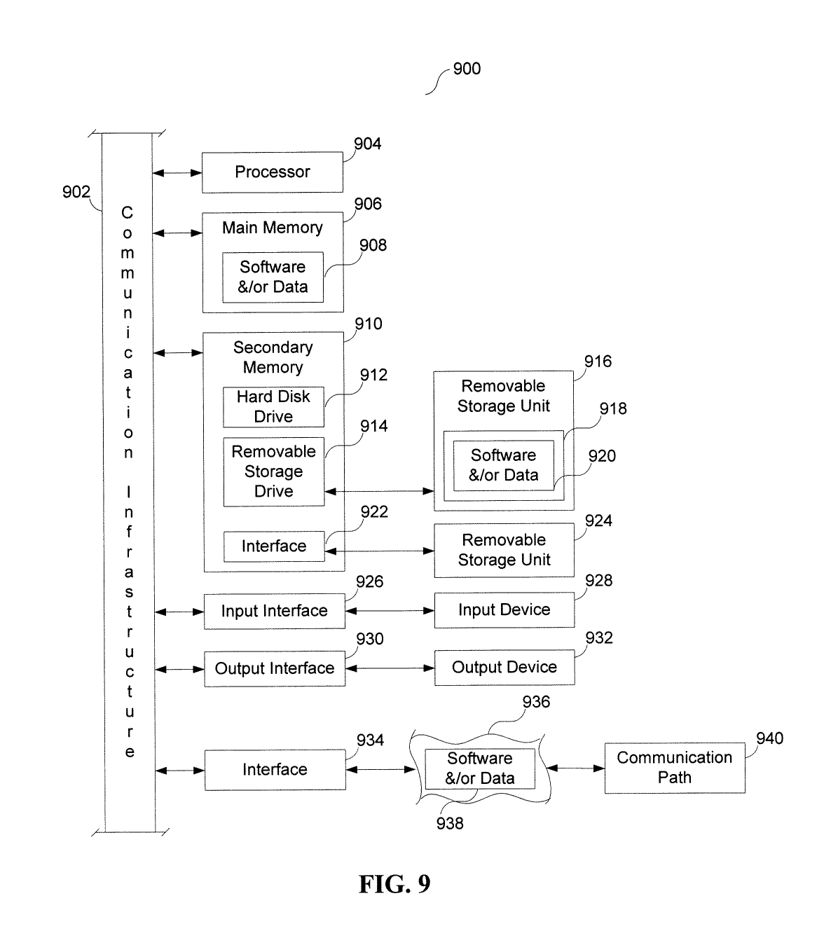

Various aspects of the present invention can be implemented by software, firmware, hardware, or any combination thereof. FIG. 9 illustrates an example computer system 900 in which the present invention, or portions thereof, (such as described above under paragraphs 12-95) can be implemented as computer-readable code. Various embodiments of the invention are described in terms of this example computer system 900. After reading this description, it will become apparent to a person skilled in the relevant art how to implement the invention using other computer systems and/or computer architectures.

Computer system 900 includes one or more processors, such as processor 904. Processor 904 can be a special purpose processor or a general purpose processor. Processor 904 is connected to a communication infrastructure 902 (for example, a bus or a network).

Computer system 900 also includes a main memory 906, preferably Random Access Memory (RAM), containing possibly inter alia computer software and/or data 908.

Computer system 900 may also include a secondary memory 910. Secondary memory 910 may include, for example, a hard disk drive 912, a removable storage drive 914, a memory stick, etc. A removable storage drive 914 may comprise a floppy disk drive, a magnetic tape drive, an optical disk drive, a flash memory, or the like. A removable storage drive 914 reads from and/or writes to a removable storage unit 916 in a well known manner. A removable storage unit 916 may comprise a floppy disk, magnetic tape, optical disk, etc. which is read by and written to by removable storage drive 914. As will be appreciated by persons skilled in the relevant art(s) removable storage unit 916 includes a computer usable storage medium 918 having stored therein possibly inter alia computer software and/or data 920.

In alternative implementations, secondary memory 910 may include other similar means for allowing computer programs or other instructions to be loaded into computer system 900. Such means may include, for example, a removable storage unit 924 and an interface 922. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 924 and interfaces 922 which allow software and data to be transferred from the removable storage unit 924 to computer system 900.

Computer system 900 may also include an input interface 926 and a range of input devices 928 such as, possibly inter alia, a keyboard, a mouse, etc.

Computer system 900 may also include an output interface 930 and a range of output devices 932 such as, possibly inter alia, a display, one or more speakers, etc.

Computer system 900 may also include a communications interface 934. Communications interface 934 allows software and/or data 938 to be transferred between computer system 900 and external devices. Communications interface 934 may include a modem, a network interface (such as an Ethernet card), a communications port, a Personal Computer Memory Card International Association (PCMCIA) slot and card, or the like. Software and/or data 938 transferred via communications interface 934 are in the form of signals 936 which may be electronic, electromagnetic, optical, or other signals capable of being received by communications interface 934. These signals 936 are provided to communications interface 934 via a communications path 940. Communications path 940 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 916, removable storage unit 924, and a hard disk installed in hard disk drive 912. Signals carried over communications path 940 can also embody the logic described herein. Computer program medium and computer usable medium can also refer to memories, such as main memory 906 and secondary memory 910, which can be memory semiconductors (e.g. Dynamic Random Access Memory (DRAM) elements, etc.). These computer program products are means for providing software to computer system 900.

Computer programs (also called computer control logic) are stored in main memory 906 and/or secondary memory 910. Computer programs may also be received via communications interface 934. Such computer programs, when executed, enable computer system 900 to implement the present invention as discussed herein. In particular, the computer programs, when executed, enable processor 904 to implement the processes of aspects of the present invention, such as the steps discussed above under paragraphs 12-95. Accordingly, such computer programs represent controllers of the computer system 900. Where the invention is implemented using software, the software may be stored in a computer program product and loaded into computer system 900 using removable storage drive 914, interface 922, hard drive 912 or communications interface 934.

The invention is also directed to computer program products comprising software stored on any computer useable medium. Such software, when executed in one or more data processing devices, causes data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

The discussion that was presented above included RTOMS. However, it is to be understood that it would be readily apparent to one of ordinary skill in the relevant art that numerous other external, target, etc. systems or platforms (such as inter alia a proprietary or a Commercially available Off-the-Shelf (COTS) inventory management system, etc.) are easily possible and indeed are fully within the scope of the present invention.

It is important to note that the hypothetical examples that were presented above, which were described in the narrative and which were illustrated in the accompanying figures, are exemplary only. They are not intended to be exhaustive or to limit the invention to the specific forms disclosed. It will be readily apparent to one of ordinary skill in the relevant art that numerous alternatives to the presented examples are easily possible and, indeed, are fully within the scope of the present invention.

The following list defines acronyms as used in this disclosure.

| Acronym | Meaning |
|---|---|
| API | Application Programming Interface |
| CCAEF | Content Collection, Aggregation, and Enhancement Facility |
| CD-ROM | Compact Disc Read-Only Memory |
| COTS | Commercially available Off-the-Shelf |
| DBMS | Database Management System |
| DH | Data Highway |
| DPE | Data Processing Engine |
| DRAM | Dynamic Random Access Memory |
| E-Mail | Electronic Mail |
| EPROM | Erasable Programmable Read-Only Memory |
| FT | Feature Tag |
| GIS | Geographic Information System |
| HTML | HyperText Markup Language |
| HTTP | HyperText Transfer Protocol |
| HTTPS | HyperText Transfer Protocol Secure |
| IT | Information Technology |
| MEMS | Microelectromechanical Systems |
| MMS | Multimedia Message Service |
| ODBMS | Object Database Management System |
| PCMCIA | Personal Computer Memory Card International Association |
| PROM | Programmable Read-Only Memory |
| RAM | Random Access Memory |
| RDBMS | Relational Database Management System |
| RF | Radio Frequency |
| RTOMS | Real-Time Offer Management System |
| SMS | Short Message Service |
| 3P | Third Party |
| URL | Uniform Resource Locator |
| WWW | World-Wide Web |
| XHTML | eXtensible HyperText Markup Language |
| XML | eXtensible Markup Language |

What is claimed is:

1. A method, performed on a computing device, that implements a Content Collection, Aggregation, and Enhancement Facility (CCAEF), the method comprising:
receiving a first set of data from a merchant system;
processing the first set of data including at least extracting one or more details therefrom, parsing the one or more extracted details, and generating one or more Feature Tags (FTs) based on the extracted details; and
sending a second set of data to a Real-Time Offer Management System (RTOMS), the second set of data being based, at least in part on the first set of data.

2. The method of claim 1, wherein the merchant system comprises a web site.

3. The method of claim 1, wherein the first set of data is in a HyperText Markup Language (HTML) form or an eXtensible Markup Language (XML) form.

4. The method of claim 1, wherein the one or more details comprise an inventory quantity and a unit price.

5. The method of claim 1, wherein the processing further includes a comparison to one or more previously generated FTs.

6. The method of claim 1, wherein the second set of data is in a text form or an eXtensible Markup Language (XML) form.
